(19) United States
(12) Patent Application Publication
(10) Pub. No.: US 2013/0141058 A1
(43) Pub. Date: Jun. 6, 2013

(54) INTEGRATED CIRCUIT DEVICE WITH INTEGRATED VOLTAGE CONTROLLER

(71) Applicant: Bryan Kris, Gilbert, AZ (US)

(72) Inventor: Bryan Kris, Gilbert, AZ (US)

(73) Assignee: Microchip Technology Incorporated

(21) Appl. No.: 13/309,633

(22) Filed: Dec. 2, 2011

(51) Int. Cl. G05F 1/10

(52) U.S. Cl. 323/271

(57) ABSTRACT

An integrated circuit device has a housing having a plurality of external pins; a central processing unit (CPU) operating at an internal core voltage and being coupled with the plurality of pins; and an internal switched mode voltage regulator receiving an external supply voltage being higher than the internal core voltage through at least first and second external pins of the plurality of external pins and generating the internal core voltage, wherein the internal switched mode voltage regulator is coupled with at least one external component through at least one further external pin of the plurality of external pins.

### TECHNICAL FIELD

The technical field of the present application relates to integrated circuit devices, in particular a microprocessor or microcontroller with integrated voltage regulator.

### BACKGROUND

Microprocessors or microcontrollers usually comprise a central processing unit (CPU) and interfaces that are fabricated with a specific technology. Microcontrollers, in addition comprise memory, and a plurality of peripheral devices to form a system on a chip that can be applied in a plurality of applications. Modern processors such as microprocessors and microcontrollers are occupying less space due to improved process technology. With decreasing process geometry, the operating voltage or core voltage in such devices is also reduced. While it was common to use a supply voltage of e.g. 5 Volts, newer devices use only 3.3 Volts or even less. At 0.18 μm process technology, the internal core voltage is 1.8 Volts. Other technologies may reduce the voltage even further, for example to 1.2 Volts. While circuit boards are often designed using 3.3V or 5V as the supply voltage, many microprocessors and/or microcontrollers generate the internal core voltage of, for example 1.8 volts or even lower core voltages, by means of an integrated voltage regulator. Such voltage regulators are traditionally linear regulators. Thus, an input power loss which is converted into heat by the linear voltage regulator of up to 45% ((3.3V-1.8V)/3.3V=45%) can occur. This waste of energy can moreover be significant in any battery operated device.

Hence, there exists a need for an improved integrated circuit device comprising a CPU.

### SUMMARY

According to an embodiment, an integrated circuit device may comprise: a housing having a plurality of external pins; a central processing unit (CPU) operating at an internal core voltage and being coupled with the plurality of pins; and an internal switched mode voltage regulator receiving an external supply voltage being higher than the internal core voltage through at least first and second external pins of the plurality of external pins and generating the internal core voltage, wherein the internal switched mode voltage regulator is coupled with at least one external component through at least one further external pin of the plurality of external pins.

According to a further embodiment, the external component may comprise an inductor. According to a further embodiment, the external component may comprise an inductor and a capacitor, wherein the inductor is coupled between a third and fourth external pin of the plurality of external pins and the capacitor is coupled between the fourth external pin and ground. According to a further embodiment, the internal switched mode voltage regulator can be a buck regulator. According to a further embodiment, the integrated circuit may further comprise a plurality of peripheral devices operating at the core voltage. According to a further embodiment, the integrated circuit may further comprise a power management unit operable to enable or disable the buck regulator. According to a further embodiment, the external supply voltage can be about 3.3 Volts and the internal core voltage is about 1.8 Volts. According to a further embodiment, the buck regulator may comprise an error amplifier coupled with a flip flop whose output controls a driving unit controlling two power field effect transistors coupled in series between the external supply voltage and ground, wherein a node between the two power field effect transistors is coupled with the third external pin and the error amplifier is coupled with the fourth external pin. According to a further embodiment, functions of the buck regulator can be trimmed by means of a special function register. According to a further embodiment, functions of the buck regulator can be trimmed by means of at least one fuse. According to a further embodiment, the buck regulator may further comprise an under voltage lockout device and a thermal shutdown device. According to a further embodiment, the buck regulator may operate with a combination of pulse width and pulse frequency modulation.

According to another embodiment, a circuit board may comprise the integrated circuit device as described above and a plurality of further integrated circuit devices operating at the external supply voltage, wherein the circuit board provides the external supply voltage as the only power supply voltage to the integrated circuit.

According to a further embodiment, a circuit board may comprise the integrated circuit device as described above and a plurality of further integrated circuit devices operating at the external supply voltage, wherein the circuit board provides the external supply voltage and no other supply voltage to the integrated circuit, further comprising at least one low voltage integrated circuit device, wherein a power supply pin of the at least one low voltage integrated circuit device is coupled with the fourth pin of the integrated circuit device.

According to yet another embodiment, a method of operating an integrated circuit device may comprise: providing a supply voltage; providing an integrated circuit device having a central processing unit (CPU) operating at an internal core voltage being lower than the external supply voltage; feeding the supply voltage to the integrated circuit; generating the internal core voltage within the integrated circuit device by means of a switched mode voltage regulator being connected to at least one external component via at least one external connection pin.

According to a further embodiment of the method, the external component may comprise an inductor. According to a further embodiment of the method, the external component may comprise an inductor and a capacitor, wherein the inductor is coupled between a third and fourth external pin of the plurality of external pins and the capacitor is coupled between the fourth external pin and ground. According to a further embodiment of the method, the internal switched mode voltage regulator can be a buck regulator. According to a further embodiment of the method, the method may further comprise a plurality of peripheral devices operating at the core voltage. According to a further embodiment of the method, the method may further comprise the step of enabling or disabling the buck regulator by a power management unit. According to a further embodiment of the method, the external supply voltage can be about 3.3 Volts and the internal core voltage is about 1.8 Volts. According to a further embodiment of the method, the method comprises: controlling a driving unit by a flip-flop coupled with an error amplifier, wherein the driving unit controls two power field effect transistors coupled in series between the external supply voltage and ground, wherein a node between the two power field effect transistors is coupled with the third external pin and the error amplifier is coupled with the fourth external pin. According to a further embodiment of the method, the method may further comprise the step of trimming at least one function of the buck regulator by programming a special function register or by setting a at least one fuse. According to a further embodiment of the method, the buck regulator further comprises an under voltage lockout device and a thermal shutdown device. According to a further embodiment of the method, the method may further comprise operating the buck regulator with a combination of pulse width and pulse frequency modulation.

Other technical advantages of the present disclosure will be readily apparent to one skilled in the art from the following figures, descriptions, and claims. Various embodiments of the present application may obtain only a subset of the advantages set forth. No one advantage is critical to the embodiments.

### BRIEF DESCRIPTION OF THE DRAWINGS

A more complete understanding of the present disclosure and advantages thereof may be acquired by referring to the following description taken in conjunction with the accompanying drawings, in which like reference numbers indicate like features, and wherein:

FIG. 1 is a block diagram showing a microcontroller according to an embodiment;

FIG. 2 shows an embodiment of an exemplary buck regulator that can be integrated with a microcontroller;

FIG. 3 shows another embodiment of a microprocessor;

FIG. 4 shows an application of a microprocessor or microcontroller as shown in FIGS. 1 and 3 with other components on a circuit board.

### DETAILED DESCRIPTION

In particular, battery powered microcontroller (MCU) applications need to minimize power consumption. While external voltage regulators could be provided, such a solution is often not acceptable in terms of space and cost requirements. Moreover, devices that use such a low internal core voltage may only be available with an integrated linear voltage regulator which can cause a reduced battery life. Thus, a more efficient external regulator may be of no use.

According to various embodiments, an integrated circuit device comprising a CPU, such as a microprocessor or microcontroller, can be provided with a switched mode power regulator such as an internal buck regulator. Such a switched voltage regulator can be designed to be very efficient. According to various embodiments, the internal switched mode voltage regulator can be designed to only require a minimum of external components such as an inductor and large capacitor. All other components such as power transistors and control circuitry can be integrated wherein according to various embodiments certain peripheral functions may be combined with the internal regulator to further save real estate on the silicon die. Moreover, the following embodiments show a buck regulator as the switched mode voltage regulator. However, while such an application is particularly beneficial other switched mode voltage regulators may be substituted for the buck regulator.

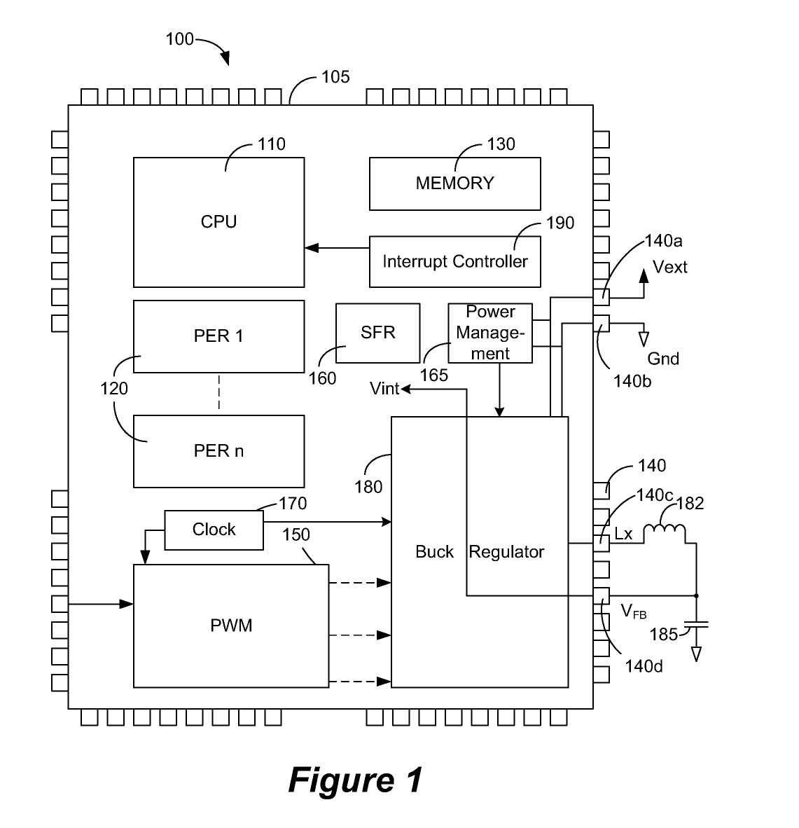

FIG. 1 shows a block diagram of a microcontroller 100 according to an embodiment. FIG. 1 shows only certain connections between components for sake of a better overview. Each connection can represent a single or multiple connection lines depending on the respective functionality. Some connections may be alternatives and may not be needed as will be appreciated by a person skilled in the art.

An integrated chip 100 is embedded in a housing 105 having a plurality of external pins 140. As typical for microcontrollers, the integrated chip 100 comprises a central processing unit 110, a plurality of peripheral devices 120 and memory 130. One of these peripheral devices can be a pulse width modulation module 150. Furthermore, according to an embodiment, the microcontroller comprises an integrated switched mode voltage regulator 180, for example a buck regulator. According to one embodiment, the buck regulator uses certain peripheral functions as for example provided by the pulse width modulation module 150. However, according to other embodiments, the switched mode voltage regulator 180 may not require resources from the microcontroller. In such a case, all peripheral functions are available to a user. The microcontroller may comprise an internal system and/or peripheral bus. Further functional units or modules are shown in FIG. 1, for example, an interrupt controller 190, a clock system 170 that may supply one or more clock signals to the pulse width modulation module 150 and to the switched mode voltage regulator 180. A power management module 165 may be provided which can control certain function, in particular when the system switches into a low power mode to further reduce power consumption of the device. The power management module may operate with the external supply voltage provided through external pins 140a and 140b. Thus, the power management module 165 may be configured to shut down all other components of the microcontroller with the exception of itself, wherein the power management unit may require only a very small supply current in Sleep mode. To this end, switched mode power regulator 180 may be operable to be switched on and off by means of the power management module 165.

The buck regulator 180 is connected with the external supply voltage Vext and with Ground through external pins 140a and 140b. As mentioned above, the buck regulator can be designed to only require a minimum of external components. In the embodiment shown in FIG. 1, only a single inductor 182 and capacitor 185 are required externally. These components 182, 185 are connected with the integrated buck regulator 180 via two additional external pins 140c and 140d. To this end, the inductor 182 is coupled between the first additional external pins 140c and 140d wherein the capacitor is connected between the second additional external pin 140d and ground. The buck regulator 180 generates the lower core voltage and supplies it internally to the various microcontroller structures that operate at this voltage as indicated with the internal voltage output Vᵢₙₜ. However, as the core voltage Vᵢₙₜ is also available at the external connection V_{FB}, other components on a circuit board may be connected to this pin.

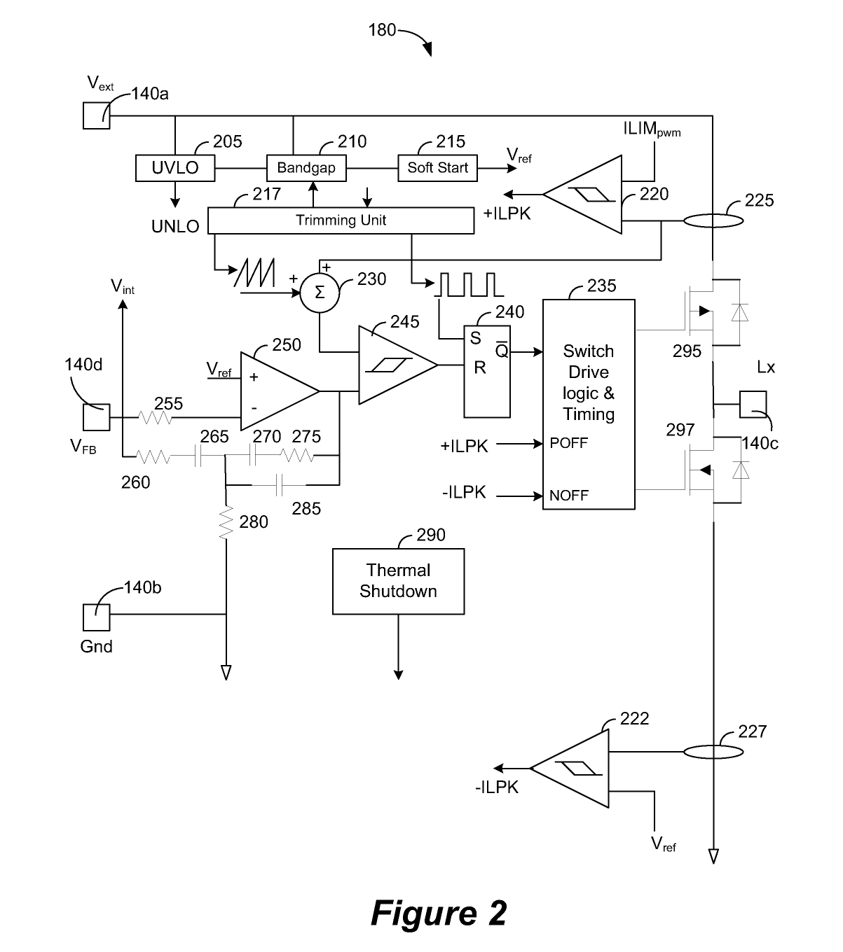

FIG. 2 shows a more detailed circuit diagram of a possible implementation of a buck regulator within a microcontroller. However, other designs may be used within a microcontroller. The buck regulator shown in FIG. 2 comprises a under voltage lock out unit 205 and a bandgap reference 210, each connected with the external supply voltage through external pin 140a. A soft start unit 215 is coupled with the output of the bandgap reference 210 and provides for the reference voltage Vref. a first operational amplifier 250 receives the reference voltage Vref at its non-inverting input and the feedback signal at its inverting input. the feedback signal is obtained through external pin 140d and a filter network consisting of resistors 255, 260, 275, and 280 and capacitors 265, 270 and 285 which are coupled between the feedback pin 140d and the output of comparator 250. The output of operational amplifier 250 is coupled with the input of a first comparator 245 whose output controls the R-input of Flip-flop 240. The S-input of flip-flop 240 receives a pulse signal. The output of flip-flop 240 drives a switch drive logic &and timing module 235 which controls the power MOSFETs 295 and 297. A second comparator compares the input current into MOSFET 295 measured by sensor 225 with a reference value ILIMpwm and generates a control signal +ILPK fed to the module 235. Similarly, a third comparator 222 compares the output current from MOSFET 297 through sensor 227 with a reference value Vref and generates a control signal—ILPK fed to the module 235. A summation point 230 receives the input current measurement signal from sensor 225 and a reference saw tooth signal. The output of summation point 230 is fed to the first comparator. The buck regulator may furthermore comprise a thermal shutdown module 290. In addition, a trimming unit 217 may be provided for certain units of the buck regulator 180. Alternatively certain units or functions of the buck regulator may be configured to be trimmed by a control unit such as the microcontroller, for example through one or more special function registers 160, or by means of at least one or more fuses etc. Also the special function register 160 used for trimming may be advantageously a configuration register that is non-volatile. The special function register 160 in particular a non-volatile configuration register may be used to control other functions and parameters of the buck regulator, such as output voltage, output current, parameters of the bandgap, over or under-voltage protection, etc.

The buck controller 180 shown in FIG. 2 is a synchronous buck regulator that operates in a Pulse Frequency Modulation (PFM) mode or a Pulse Width Modulation (PWM) mode to maximize system efficiency over the entire operating current range. However, other switched mode voltage regulators may be used as mentioned above. Capable of operating from, for example, a 2.7V to 5.5V input voltage source, the buck regulator 180 can for example deliver 500 mA of continuous output current. While in PWM mode, the device switches at a constant frequency of for example 2.0 MHz (typ) which allow for small filtering components. A variety of fixed voltage can be provided, for example, 1.2V, 1.5V 1.8V, 2.5V, 3.3,). Additionally the device features undervoltage lockout (UVLO) by unit 205, over-temperature shutdown by unit 290, over-current protection, and enable/disable control which may be controlled by the power management module 165.

Buck regulator 180 has two distinct modes of operation that allow the device to maintain a high level of efficiency throughout the entire operating current and voltage range. The device automatically switched between PWM mode and PFM mode depending upon the output load requirements. During heavy load conditions, the buck regulator 180 operates at a high, fixed switching frequency of for example 2.0 MHz (typical) using current mode control. This minimizes output ripple (10-15 mV typically) and noise while maintaining high efficiency (88% typical with VIN=3.6V, VOUT=1.8V, IOUT=300 mA). During normal PWM operation, the beginning of a switching cycle occurs when the internal P-Channel MOSFET 295 is turned on. The ramping inductor current is sensed and tied to one input of the internal high-speed comparator 245. The other input to the high-speed comparator is the error amplifier output. This is the difference between the internal 0.8V reference and the divided down output voltage. When the sensed current becomes equal to the amplified error signal, the high speed comparator 245 switches states and the P-Channel MOSFET 295 is turned off. The N-Channel MOSFET 297 is turned on until the internal oscillator sets an internal RS latch initiating the beginning of another switching cycle. PFM-to-PWM mode transition is initiated for any of the following conditions: Continuous device switching and Output voltage has dropped out of regulation.

According to an embodiment, during light load conditions, buck regulator 180 operates in a PFM mode. When buck regulator 180 enters this mode, it begins to skip pulses to minimize unnecessary quiescent current draw by reducing the number of switching cycles per second. The typical quiescent current draw for this device is for example 45 μA. PWM-to-PFM mode transition is initiated for any of the following conditions: Discontinuous inductor current is sensed for a set, duration and Inductor peak current falls below the transition threshold limit. The output of buck regulator 180 is controlled during startup. This control allows for a very minimal amount of VOUT overshoot during start-up from VIN rising above the UVLO voltage or SHDN being enabled.

Over-temperature protection circuitry 290 is integrated in the buck regulator 180. This circuitry monitors the device junction temperature and shuts the device off, if the junction temperature exceeds the typical 150° C. threshold. If this threshold is exceeded, the device will automatically restart once the junction temperature drops by approximately 10° C. The soft start unit 215 is reset during an over-temperature condition.

Cycle-by-cycle current limiting is used to protect the buck regulator 180 from being damaged when an external short circuit is applied. The typical peak current limit is for example 860 mA. If the sensed current reaches the 860 mA limit, the P-Channel MOSFET 295 is turned off, even if the output voltage is not in regulation. The device will attempt to start a new switching cycle when the internal oscillator sets the internal RS latch.

The UVLO feature uses a comparator to sense the input voltage (VIN) level. If the input voltage is lower than the voltage necessary to properly operate the buck regulator 180, the UVLO feature will hold the converter off. When VIN rises above the necessary input voltage, the UVLO is released and soft start begins. Hysteresis is built into the UVLO circuit to compensate for input impedance. For example, if there is any resistance between the input voltage source and the device when it is operating, there will be a voltage drop at the input to the device equal to IIN×RIN. The typical hysteresis is 140 mV.

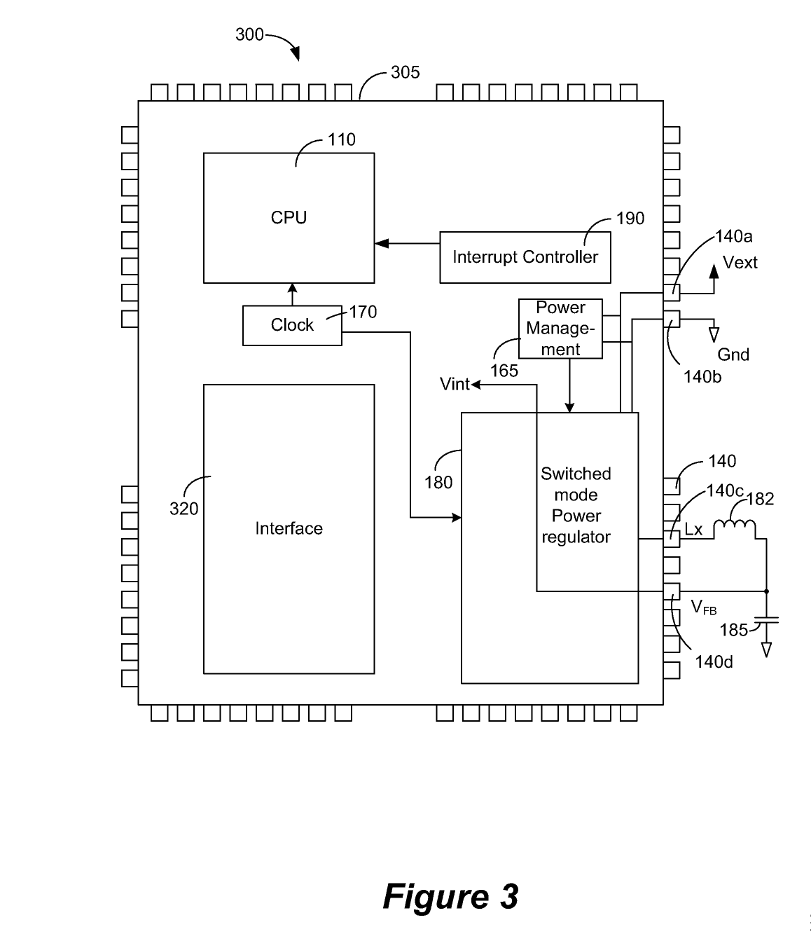

FIG. 3 shows a similar device in form of a microprocessor. Similar elements carry the same reference sign. Here, instead of a plurality of peripheral devices, only an interface module 320 to connect the device to external peripheral devices and memory may be provided. The processor 300 again has a housing 305 which contains all the essential components of a microprocessor. According to other embodiments, the device may also comprise cache memory. The switched mode Power regulator 180 may again be a buck regulator as shown in FIG. 2 and discussed above.

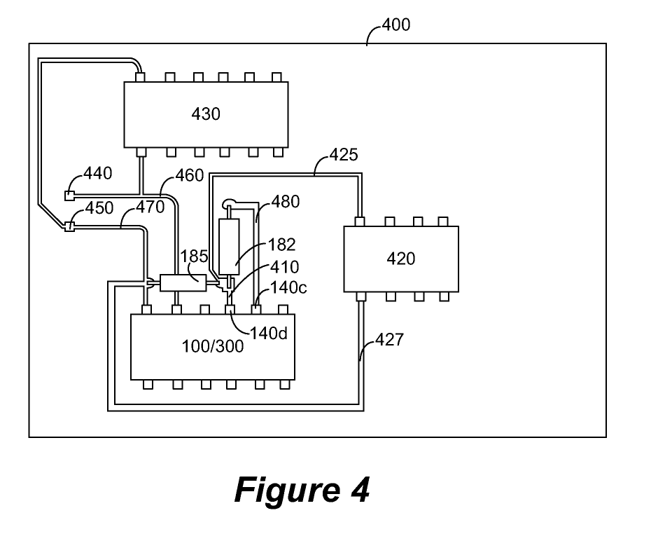

FIG. 4 shows a printed circuit board comprising an integrated circuit device 100 or 300 as shown in FIGS. 1 and 3. The printed circuit board comprises a plurality of conductive paths or track 410, 425, 426, 460, 470, 480 and connection pads 440 and 450. Furthermore additional components 182, 185, 420 and 430 are shown. Of course the circuit board 400 may comprise more or less components and additional circuit tracks. An external supply voltage generated by an external power supply is fed to the connection pads 440 and 450 such that ground is connected to pad 450 and for example 3.3 Volts to pad 440. Tracks 460 and 470 connect the power supply with the power supply pins 140a, b of integrated circuit device 100/300. The buck converter formed by internal components of integrated circuit device 100/300 and external components 182, 185 generates the internal core voltage of 1.8 Volts. To this end, circuit board 400 provides for conductive tracks 410 and 480 to properly connect the inductor 182 and capacitor 185 with the external pins 140c and 140d of integrated circuit device 100/300. The circuit board may comprise a plurality of other components which operate at the higher supply voltage of 3.3 Volts. FIG. 4 shows one such component with reference symbol 430. However, a plurality of such components may be present. Component 430 is therefore directly connected to pads 440 and 450 through extensions of circuit tracks 460 and 470, respectively. In addition, the circuit board may comprise components that operate at the lower core voltage of 1.8 Volts. FIG. 4 shows such a component with reference sign 420. In case such a component does not have its own voltage regulator, the device can be connected to ground pad 450 and external pin 140d of integrated circuit device 100/300 as external pin 140d which receives the feedback signal V_{FB} carries the regulated core voltage of for example 1.8 Volts. other components that operate with this voltage can also be connected to this pin 140d.

The invention, therefore, is well adapted to carry out the objects and attain the ends and advantages mentioned, as well as others inherent therein. While the invention has been depicted, described, and is defined by reference to particular preferred embodiments of the invention, such references do not imply a limitation on the invention, and no such limitation is to be inferred. The invention is capable of considerable modification, alteration, and equivalents in form and function, as will occur to those ordinarily skilled in the pertinent arts. The depicted and described preferred embodiments of the invention are exemplary only, and are not exhaustive of the scope of the invention. Consequently, the invention is intended to be limited only by the spirit and scope of the appended claims, giving full cognizance to equivalents in all respects.

What is claimed is:

1. An integrated circuit device comprising:
a housing having a plurality of external pins;
a central processing unit (CPU) operating at an internal core voltage and being coupled with said plurality of pins;
an internal switched mode voltage regulator receiving an external supply voltage being higher than said internal core voltage through at least first and second external pins of said plurality of external pins and generating said internal core voltage, wherein said internal switched mode voltage regulator is coupled with at least one external component through at least one further external pin of said plurality of external pins.

2. The integrated circuit device according to claim 1, wherein the external component comprises an inductor.

3. The integrated circuit device according to claim 1, wherein the external component comprises an inductor and a capacitor, wherein the inductor is coupled between a third and fourth external pin of said plurality of external pins and said capacitor is coupled between the fourth external pin and ground.

4. The integrated circuit device according to claim 3, wherein the internal switched mode voltage regulator is a buck regulator.

5. The integrated circuit device according to claim 3, further comprising a plurality of peripheral devices operating at said core voltage.

6. The integrated circuit device according to claim 3, further comprising a power management unit operable to enable or disable said buck regulator.

7. The integrated circuit device according to claim 3, wherein the external supply voltage is about 3.3 Volts and the internal core voltage is about 1.8 Volts.

8. The integrated circuit device according to claim 4, wherein the buck regulator comprises an error amplifier coupled with a flip flop whose output controls a driving unit controlling two power field effect transistors coupled in series between the external supply voltage and ground, wherein a node between said two power field effect transistors is coupled with the third external pin and said error amplifier is coupled with said fourth external pin.

9. The integrated circuit device according to claim 8, wherein functions of said buck regulator can be trimmed by means of a special function register.

10. The integrated circuit device according to claim 8, wherein functions of said buck regulator can be trimmed by means of at least one fuse.

11. The integrated circuit device according to claim 8, wherein said buck regulator further comprises an under voltage lockout device and a thermal shutdown device.

12. The integrated circuit device according to claim 8, wherein said buck regulator operates with a combination of pulse width and pulse frequency modulation.

13. A circuit board comprising the integrated circuit device according to claim 1 and a plurality of further integrated circuit devices operating at the external supply voltage, wherein said circuit board provides said external supply voltage as the only power supply voltage to said integrated circuit.

14. A circuit board comprising the integrated circuit device according to claim 3 and a plurality of further integrated circuit devices operating at the external supply voltage, wherein said circuit board provides said external supply voltage and no other supply voltage to said integrated circuit, further comprising at least one low voltage integrated circuit device, wherein a power supply pin of said at least one low voltage integrated circuit device is coupled with said fourth pin of said integrated circuit device.

15. A method of operating an integrated circuit device, comprising:
providing a supply voltage;
providing an integrated circuit device having a central processing unit (CPU) operating at an internal core voltage being lower than the external supply voltage;
feeding the supply voltage to said integrated circuit;
generating the internal core voltage within said integrated circuit device by means of a switched mode voltage regulator being connected to at least one external component via at least one external connection pin.

16. The method according to claim 15, wherein the external component comprises an inductor.

17. The method according to claim 15, wherein the external component comprises an inductor and a capacitor, wherein the inductor is coupled between a third and fourth external pin of said plurality of external pins and said capacitor is coupled between the fourth external pin and ground.

18. The method according to claim 17, wherein the internal switched mode voltage regulator is a buck regulator.

19. The method according to claim 17, further comprising a plurality of peripheral devices operating at said core voltage.

20. The method according to claim 17, further comprising enabling or disabling said buck regulator by a power management unit.

21. The method according to claim 17, wherein the external supply voltage is about 3.3 Volts and the internal core voltage is about 1.8 Volts.

22. The method according to claim 18, wherein controlling by a flip-flop coupled with an error amplifier a driving unit controlling two power field effect transistors coupled in series between the external supply voltage and ground, wherein a node between said two power field effect transistors is coupled with the third external pin and said error amplifier is coupled with said fourth external pin.

22. The method according to claim 22, further comprising the step of trimming at least one function of said buck regulator by programming a special function register or by setting a at least one fuse.

23. The method according to claim 22, wherein said buck regulator further comprises an under voltage lockout device and a thermal shutdown device.

24. The method according to claim 22, further comprising operating said buck regulator with a combination of pulse width and pulse frequency modulation.
